(19) United States
(12) Patent Application Publication
(10) Pub. No.: US 2013/0194784 A1
(43) Pub. Date: Aug. 1, 2013

(54) FLASHLIGHT CONTROL BODY HARNESS

(71) Applicant: David Yu, Laguna Niguel, CA (US)

(72) Inventor: David Yu, Laguna Niguel, CA (US)

(21) Appl. No.: 13/358,538

(22) Filed: Jan. 26, 2012

(51) Int. Cl. F21V 21/08; B23P 11/00

(52) U.S. Cl. 362/108; 29/428

(57) ABSTRACT

A flashlight control body harness system includes body straps adapted to loop around a body portion; a base having elongated slots to thread the body strap there through; a curved bottom to fit over the body portion; a flashlight strap adapted to loop around a flashlight; and a flashlight interface unit mounted above the base, the flashlight interface unit having elongated slots to receive the flashlight strap there through. A pivot lock assembly adaptably secures the flashlight interface unit on to the base and enables a beam of light directed to a desire direction.

The present invention relates to a flashlight control body harness system.

Supplemental lighting for various tasks is often important, and the conventional flashlight has proven to be a very practical response to the problem of providing supplemental lighting. However, in many instances the person requiring the supplemental lighting must use both hands to accomplish the task at hand, thus obviating the use of a hand held light. Responses to this problem are old in the art, as exemplified by helmet mounted acetylene lamps used in the mining industry in the past and more current electrically powered helmet lamps, as well as other similar devices.

However, such helmet-mounted lights are generally relatively specialized, and cannot provide the universal function of a conventional dry cell powered flashlight that includes the electrical power source and light source in a single convenient unit. Also, in many instances a hat or helmet including a Light therewith is impractical, depending upon the room or space available for wearing such an appliance, appearance requirements (e. g., military or other uniform, etc.), and/or perhaps other reasons. As a result, various bodily attachable light holders have been developed in the past in response to the above problem. Nevertheless, all of the previously developed devices lack some desired feature (e. g., provision for a conventional flashlight, adjustability, ease of installation and removal of the flashlight, etc.), which is provided by the present flashlight control body harness system.

A discussion of the related art of which the present inventor is aware, and its differences and distinctions from the present invention, is provided below.

U.S. Pat. No. 295,982 issued on Apr. 1, 1884 to James S. Conwell, titled “Band Lamp And Torch Support,” describes an upper body mounted support for a combustion type light source (kerosene lamp, etc.). The device includes waist and chest straps as well as suspender straps from which pair of supports extends to each side of the wearer's head. Various embodiments are shown for attaching the lamp to the supports, but none would be capable of holding a conventional flashlight. Moreover, no means of aiming the light is provided, as the light used with the Conwell device is omnidirectional.

U.S. Pat. No. 1,717,386 issued on Jun. 18, 1929 to Samuel Kaplan, titled “Flash Light Holder,” describes a shoulder-mounted device having a generally diagonal strap that passes beneath the opposite shoulder, with a brace extending therefrom to fit beneath the shoulder and upper arm. The flashlight is held by a simple clip, which is in turn secured to a base by a gimbal type mount. The Kaplan device does not provide the security of the present flashlight control body harness system, as the bottom of the underarm brace may shift forwardly or rearwardly, thus causing the attached strap to shift about the upper body of the wearer and causing the shoulder mounted light holder to shift accordingly. Also, the gimbal mount used by Kaplan does not provide ease of loosening or tightening for adjustment, as does the spherical mount adjustment of the present flashlight control body harness system.

U.S. Pat. No. 2,275,765 issued on Mar. 10, 1942 to Robert H. Hummert et al., titled “Portable Light,” describes an upper body harness for securing a battery pack to the back of the wearer, with a relatively large spotlight electrically connected thereto. The spotlight hangs loosely on the front of the harness when not in use, but no means for holding the light in a fixed direction is provided by Hummert et al.; the light must be aimed by hand, which precludes the use of both hands in performing a task while the light remains focused thereon by a directionally adjustable and lockable attachment, as provided by the present flashlight control body harness system.

U.S. Pat. No. 2,361,414 issued on Oct. 31, 1944 to Jesse A. Ramsey, titled “Marine Safety Light,” describes several embodiments of an omnidirectional lighting device. At least one embodiment may be secured near the shoulder of a person by means of a clip which is attached to a life vest or other garment. The Ramsey light apparatus is intended as an emergency locator device, so rescuers may spot a person at sea. Ramsey provides only a mercury type gravitationally actuated switch for his light; no manually activated switch is provided as such, other than by orienting the light as desired. As the light is omnidirectional, Ramsey does not provide any means for aiming the light in a specific direction, as provided by the present shoulder mounted flashlight control body harness system invention.

U.S. Pat. No. 2,506,685 issued on May 9, 1950 to Stanley P. Sadloski et al., titled “Shoulder-Supported Flashlight Holder,” describes a device having a shoulder mount formed of “heavy rods” (col. 1, 1. 44) with a lanyard extending from the shoulder mount around the opposite side of the body and beneath the shoulder; the device does not completely encircle the upper body for positive securing, as does the present flashlight control body harness system apparatus. While Sadloski et al. provide a locking spherical adjustment for aiming and setting the aim of the flashlight held by their device, the open top clip means used to hold the flashlight does not completely encircle the light and does not provide the positive security for the light which is provided by the present shoulder mounted flashlight control body harness system invention.

U.S. Pat. No. 2,555,871 issued on Jun. 5, 1951 to Fiore L. Caggiano, titled “Body Supported Floodlight,” describes a harness having a pair of lights extending from the back thereof on flexible “gooseneck” arms. The Caggiano lights are powered by electrical currents supplied from a fixed source (e. g., wall outlet, etc.), and thus an extension cord must be used to supply power to the device. The lights are not quickly and easily removable from their respective gooseneck attachments, whereas the present light is easily removed and replaced from its holder. Moreover, the flexibility of the gooseneck extensions, with the weight of the lights attached to the ends thereof, provides a less secure means of aiming the lights, and particularly of locking the aim as desired, than the locking spherical adjustment of the present flashlight control body harness system invention.

U.S. Pat. No. 3,731,084 issued on May 1, 1973 to Blanche P. Trevorrow, titled “Portable Flashlight,” describes a relatively small reading type light that is supported by a pair of separate shoulder braces or mounts. Batteries are contained within at least one of the shoulder mounts, with the light itself located at the distal end of two flexible “gooseneck” type attachments that extend from the two shoulder mounts and join at the light. Thus, the light cannot be separated from its gooseneck attachments or from the shoulder braces. Moreover, the Trevorrow device is not configured for holding a conventional flashlight, as is the present invention, and does not provide the positive locking of the aim of the light by means of a spherical joint, as in the present invention.

U.S. Pat. No. 5,690,413 issued on Nov. 25, 1997 to James Coughlin, titled “Safety Light For Marine Vest,” describes a light and battery pack attachment for a conventional life vest or jacket. The lamp has a rearwardly projecting stud that extends through one of the attachment strap passages of the life jacket, and engages a threaded receptacle on a plate on the opposite side of the life jacket panel. The separate battery pack attaches in the same manner. Thus, the Coughlin light is not shoulder mounted and cannot be aimed in a specific direction, except by turning the life jacket panel to which the light is attached, as by turning the upper body while wearing the life jacket. The Coughlin apparatus cannot be adapted to provide for the attachment of a conventional flashlight thereto, as provided by the present flashlight control body harness system.

U.S. Pat. No. 5,892,445 issued on Apr. 6, 1999 to Rudy G. Tomich, titled “Highway Worker Safety Signal Device,” describes a rigid frame worn about the upper body and supporting a generally vertical rod extending upwardly therefrom. The upper end of the rod has a pair of strobe or other recognition type lights extending therefrom, well above the head of the wearer on a flexible extension. The battery pack for providing electrical power to the lights is remotely located on the lower portion of the frame of the device; thus, the Tomich device is not configured for holding a conventional flashlight. As noted in many of the devices discussed above, the omnidirectional nature of the Tomich lights obviates any requirement for a specific aiming mechanism, as provided by the present shoulder mounted flashlight control body harness system invention.

U.S. Pat. No. 5,921,664 issued on Jul. 13, 1999 to Wen-Song Lee, titled “Reading Lamp,” describes a small, self-contained light and electrical power supply that is suspended from a lanyard worn about the neck of the user. No means is provided for aiming the light; rather, the light reflects from a mirror disposed in the lid of the device, when the lid is opened. The Lee device cannot be adapted to hold a conventional flashlight, as provided by the present shoulder mounted flashlight control body harness system invention.

U.S. Pat. No. 6,315,426 issued on Nov. 13, 2001 to Buller, titled “Shoulder Mounted Flashlight Holder,” describes a shoulder mounted flashlight holder provides for the hands free holding of a flashlight by the wearer thereof, enabling the wearer or user of the device to perform a task using both hands while keeping the area of interest illuminated. The holder has a rigid, curved shoulder plate that extends over one shoulder and downwardly in front of and in back of the shoulder. The plate includes a spherical swivel base, providing for the adjustment of the aim of a flashlight secured thereto as desired. The plate is well padded for the comfort of the user, and includes forward and rearward extensions for the attachment of a torso encircling belt or strap, for fastening the shoulder harness portion. The encircling belt extends from the rear portion of the shoulder harness, around the torso of the wearer to attach to another strap depending from the front of the shoulder harness. A flashlight is removably secured in a rigid channel, which is in turn adjustably secure to the spherical swivel base by a mating ball connection. The assembly may be locked in position as desired. The flashlight is secured in the channel by an elastomer fabric sleeve that fits securely about the body of the flashlight to hold it in place in the channel. The flashlight switch is readily operable through the resilient elastomer fabric material.

In Buller, the user places the rigid harness over the shoulder and fastens the harness around the torso by way of belts to secure a flashlight for hands free illumination of a task. Once the flashlight is in place it will move in concert with the user's torso, the upper body, and would not be affected by any shoulder movements while the present flashlight control body harness system secures the device on the shoulder and redirect the aim of the flashlight with any shoulder movements. Whereas in Buller invention the belts cannot be fully tightened around the torso that would certainly restrict the respiration of the user. Therefore, this rigid harness system is presumably just sat over the shoulder similar to the fashion that a hat is sitting on one's head. The present invention requires that the straps around any body parts be able to be tightened to secure the device on the body part, it cannot be just sitting on top but rather secured to the body part. Because of its size, the Buller invention is specifically designed to be use on top of the shoulder while the present invention is designed to fit in and for the uses on various parts of the user's body.

### SUMMARY

In one aspect, a flashlight control body harness system includes a body strap adapted to loop around a body portion; a base having elongated slots to thread the body strap there through; a curved bottom to fit over the body portion; a flashlight strap adapted to loop around a flashlight; and a flashlight interface unit mounted above the base, the flashlight interface unit having elongated slots to receive the flashlight strap there through.

Implementations of the above aspect may include one or more of the following. A padding pouch can be positioned between the base and the user. The padding pouch can have padding pouch straps slidably around the base; wherein the padding pouch straps include hooks and loops to attach the padding pouch straps. The body strap can mount the base to an arm, a calf, a wrist, a head and/or shoulder. The body strap can also be a belt and buckle to mount the base to a waist. The flashlight interface unit can include a friction pad on a first surface and a screw on a second face.

It is an object of the invention to provide an improved aiming and positioning of a flashlight for hands free operation. A pivot lock assembly provides a means to lock in the aiming and positioning of a flashlight and is used to mount the flashlight interface unit to the base. A pivot lock assembly can have a ball joint assembly and a locking assembly. The ball joint can be a spherical or semispherical ball joint type pivot assembly. The locking assembly comprises a locking nut and rubber washer threaded on to the screw rod on the bottom of the flashlight interface unit. When the locking nut and rubber washer is tightened towards the ball joint assembly by screwing towards it. This tightening restricts the movement of the flashlight interface unit and thus locks in the aim and position of the flashlight.

Implementations of the above aspect can include one or more of the following. The system can have a calf flashlight control body harness system including a body strap adapted to loop around a calf; a wrist flashlight control body harness system including a body strap adapted to loop around a wrist; a shoulder flashlight control body harness system including a body strap adapted to loop around one or both armpits; a waist flashlight control body harness system including a body strap adapted to loop around the waist, body straps can be a belt and buckle to mount the base to a waist; a head flashlight control body harness system including a body strap adapted to loop around the top of the head, the body strap can be a headband; a arm flashlight control body harness system including a body strap adapted to loop around the arm. All of these system has a base having: elongated slots to thread the body strap there through; a curved bottom to fit over the body portion; a flashlight strap adapted to loop around a flashlight; and a flashlight interface unit mounted above the base, the flashlight interface unit having elongated slots to receive the flashlight strap there through.

Implementations of the above aspects can include one or more of the following. Padding can be installed on the bottom of the base to provide wearing comfort. The method can include strapping a flashlight to a head; strapping a flashlight to a shoulder; strapping a flashlight to a waist; strapping a flashlight to a wrist; strapping a flashlight to an arm and strapping a flashlight to a calf.

Advantages of the above systems may include one or more of the following. When working in an area, it is sometimes desired to illuminate the area in order to view the area. Instead of conventionally using a flashlight that generally require hand operation for use, the user of the foregoing flashlight control body harness system has complete hands-free illumination so that s/he can perform the desired work with ease. For example, a situation requiring illumination is in accident scene investigations. Typically after an accident, a law enforcement officer or an insurance adjuster needs to take measurements at the accident scene to determine such things as distance of skid marks or distance between objects. Such operation at night can require three tasks to be done concurrently: 1) operate a wheeled measuring device, 2) hold/aim the flashlight, and 3) record the measurement. The system minimizes the need for shuffling the wheeled measuring device, flashlight, and paper and pen. In situations in the construction, repair, or manufacturing industries it may be desirable to direct a beam of light to a restricted area. For this purpose, the system provides the needed light beam, and leaves the hands free so that both of his hands are available for the work being done. In the case of the installation of an electrical system, there are many situations where no electrical power is available for use with work lamps and a flashlight can be conveniently used to illuminate a dark recess. In the case of automotive servicing, the flashlight control body harness system would be able to be aimed appropriately without using hands.

### BRIEF DESCRIPTION OF THE DRAWINGS

FIG. 1 shows a detailed view of an exemplary flashlight control body harness system.

FIG. 2 shows components of a padding assembly and a flashlight strap for the flashlight.

FIG. 3 shows exemplary flashlight control body harness systems for a shoulder and waist.

FIG. 4 shows an embodiment of a flashlight control body harness system for the leg.

FIG. 5A-5A shows various views of an exemplary wrist-mounted flashlight control body harness embodiments.

FIG. 6 shows embodiment of a flashlight control body harness systems for lesser size flashlights.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the preferred embodiment will be described in detail by way of example with reference to the attached drawings. Throughout this description, the preferred embodiment and examples shown should be considered as exemplars, rather than as limitations on the preferred embodiment and any equivalents thereto. Furthermore, reference to various feature(s) of the preferred embodiment throughout this document does not mean that all claimed embodiments or methods must include the referenced feature(s).

When working in an area, it is sometimes desired to illuminate the area in order to view the area. Instead of using flashlights conventionally which generally require hand operation for use, the user of the present flashlight control body harness system has complete hands-free illumination so that s/he can perform the desired work with ease.

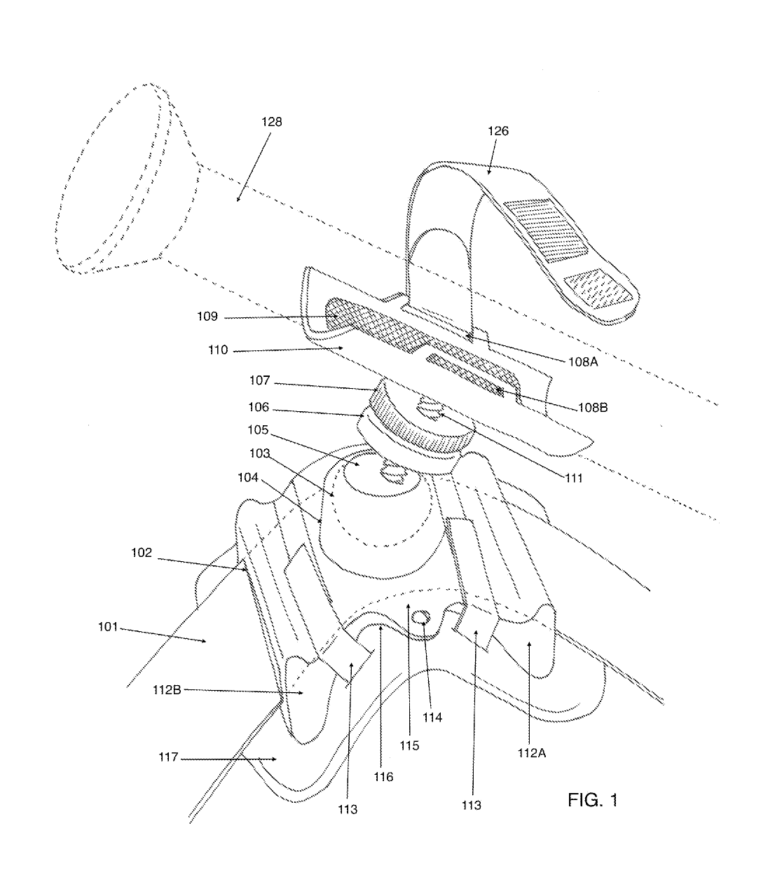

FIG. 1 shows a detailed view of an exemplary flashlight control body harness system. In FIG. 1, a base 115 has curved sides 116 that extend to end portions with elongated openings 102 that receive a body conforming strap there through to secure the base 115 to the body of the flashlight control harness system wearer.

The ball joint assembly 104 comprises of a spherical or semispherical hollow sphere with an opening on top 105. The opening on top 105 is larger then the diameter of the screw rod 111 to provide enough space for omnidirectional movement of the screw rod 111. The bottom of the screw rod 111 is attached to a spherical or semispherical pivot unit 103 (represented by dashed lines). The pivot unit 103 prevents the flashlight interface unit 110 from detaching from the ball joint assembly 104. The movement of the assembly can improve the aiming and positioning of a flashlight 128 (dashed lines). The ball joint assembly 104 is securely attached to the base 115 while the screw rod 111 is securely attached to the flashlight interface unit 110.

The base 115 operates with the ball joint assembly 104 to rotatably secure the flashlight 128 into a user selectable predetermined position. The pivot locking assembly includes a pivot unit 103 that is slightly larger than the opening 105 on the top of the ball joint assembly 104. The pivot unit 103 has an extended screw rod 111. The pivot unit 103 is adapted to engage within a sphere or half-sphere ball joint 104 attached to the flashlight interface unit 110. To provide secured aiming and positioning of the flashlight, the screw rod 111 is inserted through a rubber washer 106 and a locking nut 107.

The sphere or half sphere pivot unit 103 moves inside the ball joint assembly 104 and is restricted by the rubber washer 106 and locking nuts 107 which result in the ability to aim and position the flashlight 128 around.

The base 115 can be curved and can be adjusted to fit a particular body mounting position. The bottom of the base 115 can be padded to provide comfort during wear. The base 115 has two extended side portions 112A and 112B with an elongated recess 102 extending through the side portions 112A-112B to receive a strap 101. The strap 101 secures the base 115 to a person, such as the calf or wrist, for example.

The flashlight interface unit 110 with elongated openings 108A-108B that receive a flashlight strap 126 there through. The flashlight interface unit 110 holds a flashlight 128. The flashlight interface unit 110 has a friction pad 109 made of rubber or similar material in one embodiment. The friction pad 109 helps by holding the flashlight tighter and reducing movement of the flashlight so that the user does not need to reposition the flashlight. To wear the device, the body strap 101 is inserted through the elongated recess 102 on the bottom of the base 115. The entire flashlight-strap assembly is secured to the body with strap 101, and the flashlight is similarly secured with band 126 threaded through the elongated openings 108A-108B on the sides of the flashlight interface unit 110.

During operation, the flashlight 128 (shown as dashed lines) is inserted into the flashlight strap 126 that in turn inserted into the elongated slots of the flashlight interface unit. The locking nut 107 and rubber washer 106 is secured to a sphere or half sphere pivot unit 103 inside the ball joint assembly 104 on the base 115 to allow rotation of the flashlight 128. The ball joint assembly 104 is attached to the base 115. The body strap 101 inserted through elongated slots 102 secured the base 115 to the user's body part while retaining a padding pouch 117 in the same curvature as the body strap 101 in relation to the body part. Pouch straps 113 slidably secure the padding pouch 117 on to the base 115. Pouch straps 113 can slide between the ball joint assembly 104 and the raises on the top of the side portions 112A-112B. The raises on the top of side portions 112A-112B prevent pouch straps 113 from sliding off the base 115.

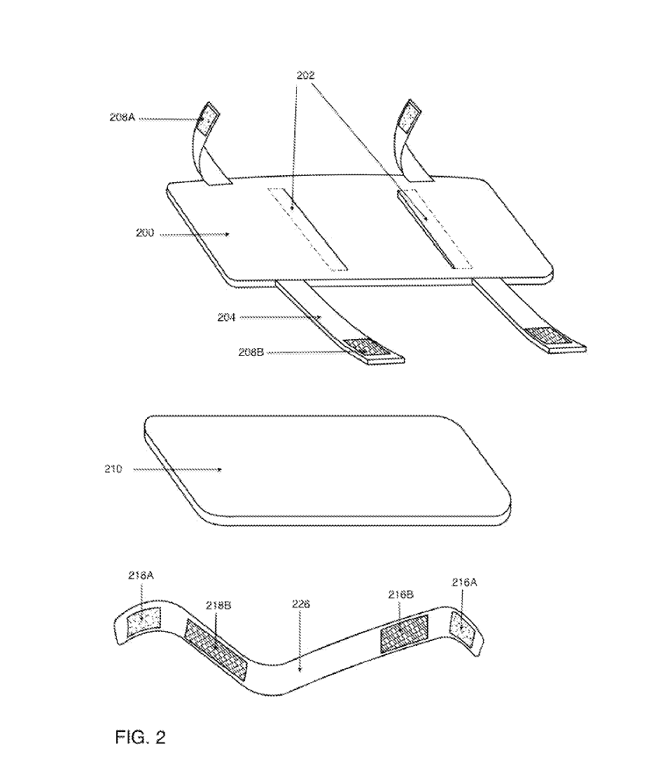

FIG. 2 shows exemplary components of a padding assembly and the flashlight strap for the flashlight control body harness system described above. The padding assembly acts a barrier between the user's skin and the hard surface on the base of the flashlight control body harness system. The cushion prevents the backing of the base from making contact with the skin underneath. This cushion can be replaced if the device is transferred to a new owner and prolongs the use of the flashlight holder. Second, the cushion is a vapor barrier between the skin and the base. Third, the cushion provides comfort for the user and the cushion is ideal for those who prefer wearing the device all day long. Fourth, the soft and flexible cushion adjusts and curves to the body part. Fifth, the cushion prevents the body strap 214 from making contact with the skin underneath.

Padding pouch 200 has openings 202 to insert padding 210 inside the pouch 200. Padding 210 consists of soft cushioning material such as rubber, silicon or similar material. Pouch straps 204 secure each side of the pouch 200 to the base 115 by wrapping around each end of the base 115 on the extended side portions 112A and 112B. Each pouch strap 204 can be a band 208A with Velcro or suitable loop and hook attachments mounted on one side and adapted to be secured to a second band 208B with suitable loop and hook attachments on the other side of the pouch strap. During operation, the body strap 101 is inserted through slots 102 and loop around a body part. The body strap 101 being padded and protected by the padding assembly is curved around the body part while securing the base 115 to the body part.

As illustrated in FIG. 2, both ends of the flashlight holder strap 226 ends with the loops and hooks 216A, 216B and 218A and 218B. During operation, one end of the strap such as 216A or 218A would secure the strap to the elongated slots of either 108A or 108B and the other end would threaded through the other slot while securing a flashlight 128 in the flashlight interface unit 110.

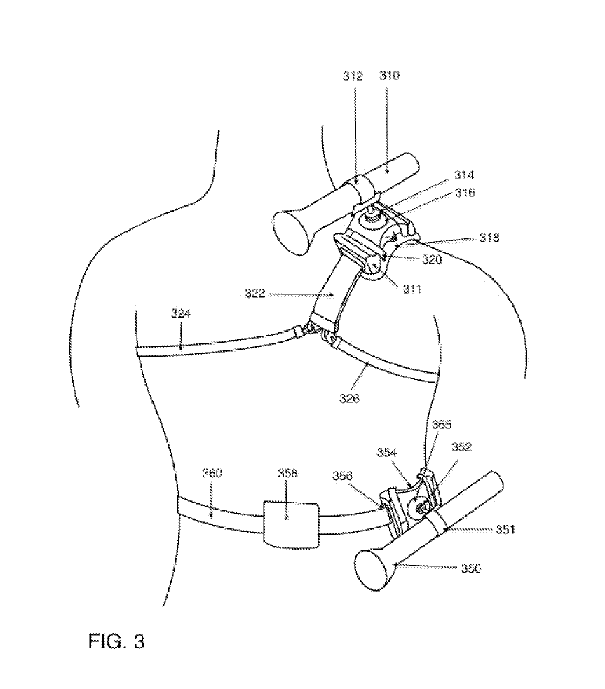

FIG. 3 shows exemplary flashlight control body harness systems. In FIG. 3, a flashlight 310 is secured by a loop or band 312 to a base 311. The base 311 has a locking nut and rubber washer 314 that allows flashlight 310 to be rotatably mounted to the base 311 through the ball joint assembly 316. The locking nut and rubber washer 314 rest above a sphere or half sphere ball joint 316 accommodate rotations. The base 311 rests above a curved padding 318 that in turn rests above the users shoulder in this embodiment. The base 311 in turn is secured to the padding pouch 318 with one or more padding straps 320. The base 311 is also secured to the body of the user through straps 322, 324, 326. In this embodiment, straps 324, 326 are attached to strap 322.

During operation, the flashlight 310 of FIG. 3 is inserted into the loop 312 that extends from the flashlight interface unit 110. The flashlight interface unit 110 through the locking nut and rubber washer 314 in turn is secured to a sphere or half sphere pivot unit 103 inside the ball joint 316 on the base 311 to allow rotation of the flashlight 310. The padding 318 held in by padding straps 320 is curved by the curved shape formed by the body strap 322 to accommodate the shape of the shoulder of the user or wearer.

A second flashlight 350 is secured to a band or strap 351 that is rotatably secured to a second base 354 through a ball joint assembly 365 and a locking nut and rubber washer 352. In this embodiment, the second base 354 does not have padding. The base 354 is secured to the waist of the user through a combination of a belt 360 and a buckle 358. When it is inserted into the strap 351, the flashlight 350 can be suspended at a predetermined angle with the locking nut and rubber washer 352 and the ball joint assembly 365. The assembly of the base 354 is then secured to the waist of the user. User can secure the base 354 to the waist by threading the belt 360 through the elongated recess 356 of the padless base 354 and the user can adjust the belt size using a belt buckle 358.

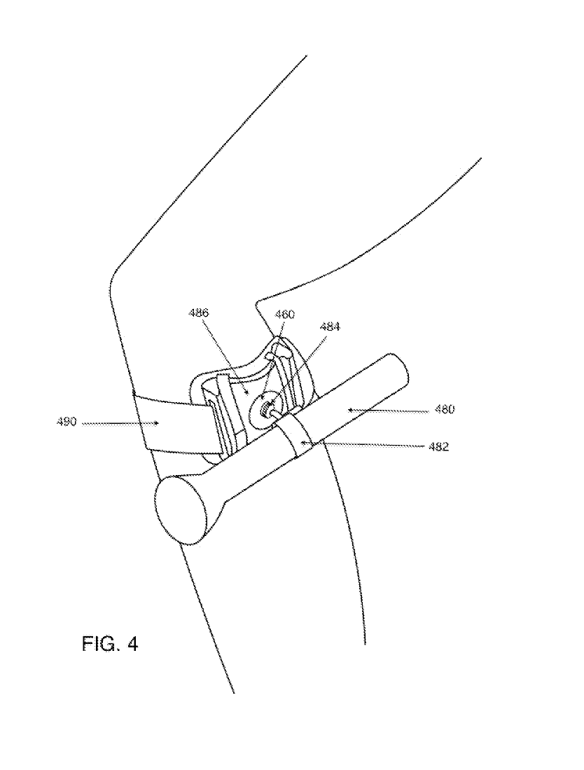

Referring now to FIG. 4, a third embodiment of a flashlight control body harness system for the leg is illustrated. In this embodiment a flashlight 480 is rotatably secured to a base 486 by use of a strap 482. The flashlight and strap assembly is secured to the base by a ball joint assembly 460 and a locking nut and rubber washer 484, which in turn is secured to the user's calf by use of a strap 490. During use, the strap 490 is wrapped around the calf, and the flashlight 480 is inserted into the loop 482. The position of the flashlight 480 is adjusted by the locking nut and rubber washer 484 and the ball joint assembly 460. The user can periodically adjust the aim of the flashlight 480 as desired.

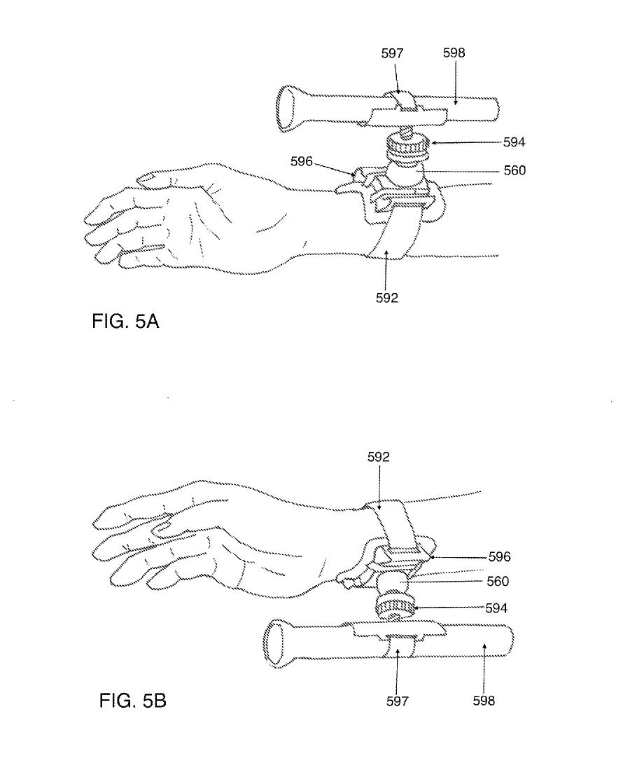

FIG. 5A-5B shows various views of an exemplary wrist-mounted flashlight embodiment of the flashlight control body harness system. A flashlight 598 is secured by a loop or band 597 to a base 596. FIG. 5A and 5B shows the flashlight 598 positioned in alignment with the user's thumb, while FIG. 5A shows the flashlight 598 positioned above the palm and FIG. 5B shows it below the palm. The base 596 has a locking nut and rubber washer 594 that allows flashlight 598 to be rotatably mounted to the ball joint assembly 560 on the base 596. The base 596 rests above a curved padding 560 to the user's wrist to provide a comfortable interface with the wrist when the base 596 is worn. The base 596 in turn is secured to the wrist with one or more straps 592. In this embodiment, the user can flick or move the wrist or by rotating the ball joint 560 and the locking and washer 594 to aim and lock the aim of the light as desired.

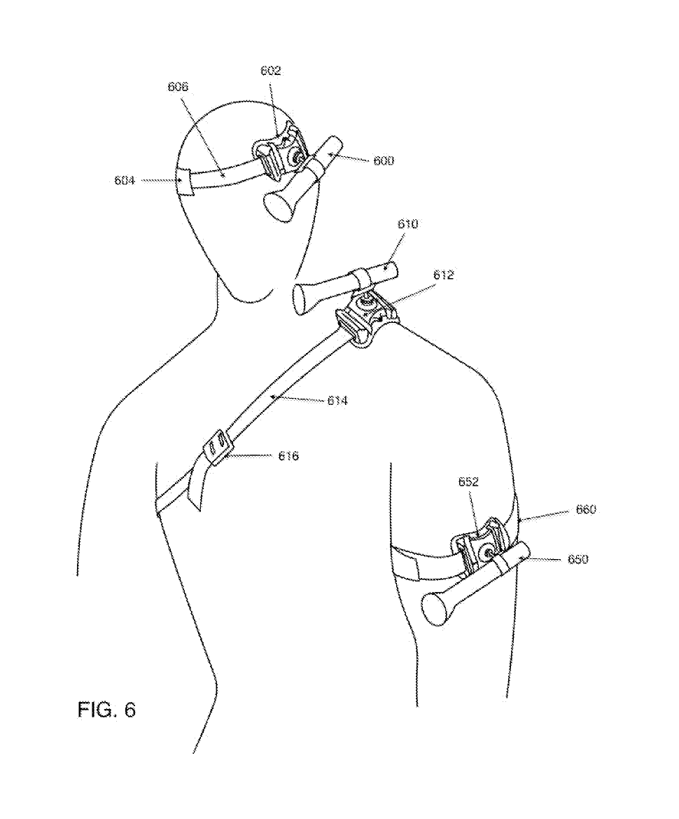

Turning now to FIG. 6, shows exemplary flashlight control body harness systems are shown. Systems shown in FIG. 6 can be for lesser flashlight sizes. In these embodiments, a head base 602 rotatably secures a flashlight 600 to the head of the user using a head strap 606 and a buckle 604. A shoulder-mounted flashlight 610 is rotatably secured to a shoulder base 612. A shoulder base 612 in turn is secured to a user's shoulder by way of a strap 614 and a buckle 616. Correspondingly, an arm-mounted flashlight 650 is rotatably secured to a base 652 that in turn is secured to the users arm by a strap 660.

During use, the flashlight 600 is attached onto a loop and is secured to the holder and to the base 602, which in turn is attached to the headband 606. Headband 606 secures the base 602 to the top of the head. Similarly, the flashlight 610 is attached to the shoulder base 612 where the body strap 614 holds the flashlight 610 to the body with an adjustable clip 616. The flashlight 650 is attached to the base 652 and then mounted on an arm. The base 652 is held in place by strap 660. Aiming and positioning of the flashlight can be accomplished by the rotation and securing of the pivot lock assembly.

While various embodiments have been described above, it should be understood that they have been presented by way of example only, and not of limitation. Likewise, the various diagrams may depict an example of the preferred embodiment, which is done to aid in understanding the features and functionality that may be included in the embodiment. The present system is not restricted to the illustrated example designs or configurations, but the desired features may be implemented using a variety of alternative designs and configurations. Indeed, it will be apparent to one of skill in the art how alternative functional, logical or physical partitioning and configurations may be implemented to implement the desired features of the present apparatus. Additionally, with regard to flow diagrams, operational descriptions and method claims, the order in which the steps are presented herein shall not mandate that various embodiments be implemented to perform the recited functionality in the same order unless the context dictates otherwise.

The system is ideal when the user of the foregoing flashlight control body harness system needs complete hands-free illumination so that s/he can perform the desired work with ease. For example, one particular situation requiring illumination is accident scene investigations. Typically after an accident, a law enforcement officer or an insurance adjuster needs to take measurements at the accident scene to determine such things as distance of skid marks or distance between objects. Such operation at night can require three tasks to be done concurrently: 1) operate a wheeled measuring device, 2) hold/aim the flashlight, and 3) record the measurement. The system minimizes the need for shuffling the wheeled measuring device, flashlight, and paper and pen.

In situations in the construction, repair, or manufacturing industries it may be desirable to direct a beam of light to a restricted area. For this purpose, the system provides the needed light beam, and leaves the hands free so that both of his hands are available for the work being done. In the case of the installation of an electrical system, there are many situations where no electrical power is available for use with work lamps and a flashlight can be conveniently used to illuminate a dark recess. In the case of automotive servicing, the flashlight control body harness system would be able to be aimed appropriately without using hands.

Although the above system is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments, whether or not such embodiments are described and whether or not such features are presented as being a part of a described embodiment. Thus the breadth and scope of the present system should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The foregoing description of various disclosed embodiments is provided to enable any person skilled in the art to make or use the present invention. The description is not intended to be limited to the embodiments shown herein but is to be accorded the widest scope consistent with the principles and novel features disclosed herein.

Various modifications and alterations of the above apparatus will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

What is claimed is:

1. A flashlight control body harness system, comprising
body straps adapted to loop around a body portion;
a base having:
elongated slots to thread the body strap there through;
a curved bottom to fit over the body portion; and
a pivot lock ball joint assembly;
a flashlight strap adapted to loop around a flashlight;
a flashlight interface unit mounted above the base, the flashlight interface unit having elongated slots to receive the flashlight strap there through and a friction pad on its surface; and
a padding positioned between the base and the user.

2. The flashlight control body harness system of claim 1, wherein the body straps mounts the base to a shoulder.

3. The flashlight control body harness system of claim 1, wherein the body strap comprises a belt and buckle to mount the base to a waist.

4. The flashlight control body harness system of claim 1, wherein the body strap mounts the base to an arm.

5. The flashlight control body harness system of claim 1, wherein the body strap mounts the base to a calf.

6. The flashlight control body harness system of claim 1, wherein the body strap mounts the base to a wrist.

7. The flashlight control body harness system of claim 1, wherein the body strap comprises a headband and mounts the base around the head.

8. The flashlight control body harness system of claim 1, wherein the pivot lock ball joint assembly comprises
a ball joint assembly;
a spherical or semispherical pivot unit having a radius larger than the radius of the opening on top of the ball joint assembly. The pivot unit is contained within the ball joint assembly. The pivot unit has a screw rod extending out and pass through the opening on top of the ball joint assembly to attach to the flashlight interface unit;
a locking nut and rubber washer. The locking nut and rubber washer is screwed on the screw rod connecting the flashlight interface unit and the pivot unit; and
to adaptably mount the flashlight interface unit to the base.

9. The flashlight control body harness system of claim 1, wherein the padding pouch comprises a pad and padding pouch straps slidably threaded through the padding pouch, wherein the padding pouch straps include hooks and loops to attach the padding pouch straps.

10. An illumination system, comprising:
a head flashlight control body harness system including:
a body strap such as a headband adapted to loop around a head;
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through;
an arm flashlight control body harness system including:
a body strap adapted to loop around an arm;
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through; and
a shoulder flashlight control body harness system including:
body strap(s) adapted to loop around armpit(s);
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through.
a calf flashlight control body harness system including
a body strap adapted to loop around a calf;
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through.
a wrist flashlight control body harness system including
a body strap adapted to loop around a wrist;
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through.
a waist flashlight control body harness system including
a body straps comprises a belt and buckle to mount the base to a waist.
a base having:
elongated slots to thread the body strap there through;
a curved bottom to fit over the body portion; and
a pivot lock ball joint assembly;
a flashlight strap adapted to loop around a flashlight; and
a flashlight interface unit mounted above the base, the flashlight interface unit having elongated slots to receive the flashlight strap there through.

11. A method of directing and securing the aim of the flashlight, comprising:
looping one or more body straps around a body portion to attach a base having:
elongated slots to thread the body strap there through;
a curved bottom to fit over the body portion; and
a pivot lock ball joint assembly;
looping a flashlight strap around a flashlight with a flashlight interface unit mounted above the base, the flashlight interface unit having elongated slots to receive the flashlight strap there through; and
moving a pivot lock ball joint assembly to aim the flashlight, wherein when a locking nut and a rubber washer of the pivot lock ball joint assembly is tightened along the screw rod connecting and towards the pivot unit, the pivot lock ball joint assembly restricts the movements of the flashlight interface unit and locks the unit in place.

12. The method of claim 11, comprising:
strapping a flashlight to a head;
strapping a flashlight to an arm;
strapping a flashlight to a shoulder;
strapping a flashlight to a waist;
strapping a flashlight to a wrist; and
strapping a flashlight to a calf.

13. A method of securing a flashlight to the flashlight interface unit, comprising:
a flashlight holder;
a friction pad on the surface of the flashlight holder;
a flashlight strap adapted to loop around a flashlight;
mounting a flashlight interface unit above the base, the flashlight interface unit having elongated slots to receive the flashlight strap there through; and
looping a flashlight strap through the elongated slots to secure a flashlight to the flashlight interface unit.

14. A method to secure a flashlight on a body portion, comprising:
threading a body strap through elongated slots of a base and looping the body strap around the body portion to secure the base to the body portion;
mounting a flashlight interface unit to the base using the pivot lock ball joint assembly, the flashlight interface unit having elongated slots and a fraction pad on its surface;
looping a flashlight strap through the elongated slots to secure a flashlight to the flashlight interface unit; and
padding the base to provide wearing comfort, wherein the padding slidably conforms to the body part while held in place by the body strap and wherein padding pouch straps are slidably holding the padding pouch to the base.

15. The method of claim 14, comprising:
strapping a flashlight to a head;
strapping a flashlight to an arm;
strapping a flashlight to a shoulder;
strapping a flashlight to a waist;
strapping a flashlight to a wrist; and
strapping a flashlight to a calf.
